(19) United States
(12) Patent Application Publication
(10) Pub. No.: US 2016/0025310 A1
(43) Pub. Date: Jan. 28, 2016

(54) Accessory Clip System

(71) Applicant: David Gurrola, Carson, CA (US)

(72) Inventor: David Gurrola, Carson, CA (US)

(21) Appl. No.: 14/809,110

(22) Filed: Jul. 24, 2015

Related U.S. Application Data
(60) Provisional application No. 62/029,309, filed on Jul. 25, 2014.

(51) Int. Cl. F21V 21/088; F21L 4/00; F21V 23/06; H01R 13/02

(52) U.S. Cl. CPC F21V 21/0885; H01R 13/02; F21L 4/00; F21V 23/06; F21Y 2101/02

(57) ABSTRACT

An accessory clip system includes a display clip having a front member. The front member has a front member outside face and a front member inside face. The front member has a flat area for displaying a graphic. The display clip front member has a pair of sides, namely a left side and a right side. A first prong of the display clip extends from the front member. The first prong of the display clip has a generally flat and horizontal orientation. A second prong of the display clip extending from the front member. The second prong of the display clip has a generally flat and horizontal orientation.

This application is a non-provisional continuation in part of U.S. provisional application 62/029,309 filed Jul. 25, 2014, by inventor David Gurrola of Carson, Calif., the disclosure of which is incorporated herein by reference.

### FIELD OF THE INVENTION

The present invention is in the field of accessory clips, namely decorative clips.

### DISCUSSION OF RELATED ART

A variety of different decorations and ornamentation can be attached to clothing such as by pins, clips and adhesive. Some of the decorations have a lighted feature.

SUMMARY OF THE INVENTION

An accessory clip system includes a display clip having a front member. The front member has a front member outside face and a front member inside face. The front member has a flat area for displaying a graphic. The display clip front member has a pair of sides, namely a left side and a right side. A first prong of the display clip extends from the front member. The first prong of the display clip has a generally flat and horizontal orientation. A second prong of the display clip extends from the front member. The second prong of the display clip has a generally flat and horizontal orientation.

The accessory clip system may also have some optional features. A battery clip can have a battery housed within the battery clip, and the battery can have a negative terminal and a positive terminal. The negative terminal is connected to a negative terminal conductor and the positive terminal is connected to a positive terminal conductor. An electrical circuit can be connected to the battery clip. An LED of the display clip can be mounted to the front member. The LED is connected to the electrical circuit.

A first prong of the battery clip extends from the front member. The first prong of the battery clip has a generally flat and horizontal orientation. A second prong of the battery clip extends from the front member. The second prong of the battery clip has a generally fiat and horizontal orientation. The battery clip can also have an LED light on it so that it functions independently without other clips.

The electrical connector can be a pair of external conductive contacts disposed on the left side or the right side. The left side and the right side are generally flat. The front member outside face is angled downward to allow forward display while the clip is attached to a baseball cap brim that is tilted back, but the front member outside face angle should not be more than a 45° angle unless designed for special situations such as children viewing adults. The accessory clip system further includes a terminating clip. The terminating clip completes the electrical circuit. The accessory clip system can be made so that it does not complete the circuit without the terminating clip. This would be helpful in the case where each clip has a word and the terminating clip can be ending punctuation. The electrical circuit can thus ensure proper punctuation or enforce other rules of grammar such as requiring that a word with a capital letter be the first word of the sentence.

A first prong of the accessory clip extends from the front member. The first prong of the accessory clip has a generally flat and horizontal orientation. A second prong of the accessory clip extends from the front member. The second prong of the accessory clip has a generally flat and horizontal orientation. The electrical connector is a copper contact that is semi-spherical in shape. Each prong of the clips of the accessory clip system preferably has a specific shape. A lower prong rear bevel face faces upward and terminates at a lower prong rear tip and an upper prong rear bevel face faces upward and terminates at an upper prong rear tip.

### BRIEF DESCRIPTION OF THE DRAWINGS

FIG. 1 is a perspective view of the present invention.

FIG. 2 is a front view of the present invention intermediate clip which can be the display clip showing the graphic such as a letter, character, image or word.

FIG. 3 is a side view of the present invention intermediate clip.

FIG. 4 is a side view of the present invention battery clip with an optional LED.

FIG. 5 is a front cross section diagram of the present invention battery clip.

FIG. 6 is a side view of the present invention intermediate clip with an optional LED.

FIG. 7 is a front view diagram of the present invention intermediate clip.

FIG. 8 is a sample circuit diagram of the circuit with the terminating clip and the intermediate clip connecting, but with the battery clip separated by a distance so that the circuit is not energized and the light is turned off.

FIG. 9 is a front view of how variations of the present invention can be installed on the brim of a baseball cap.

FIG. 10 is a perspective view of the present invention installed on the brim of a baseball cap.

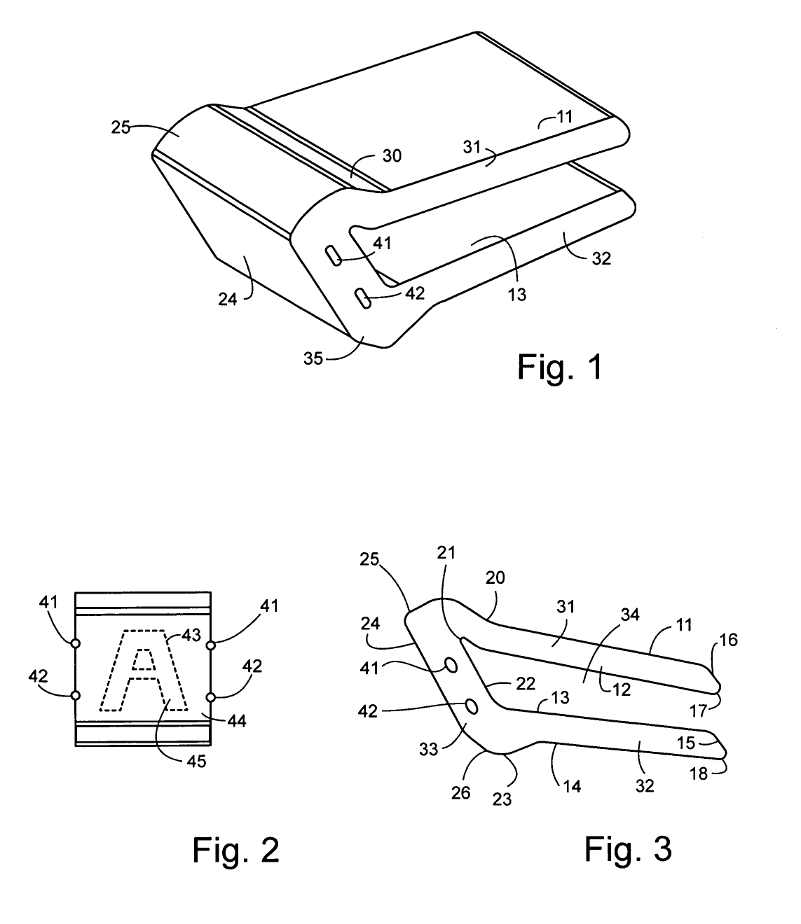

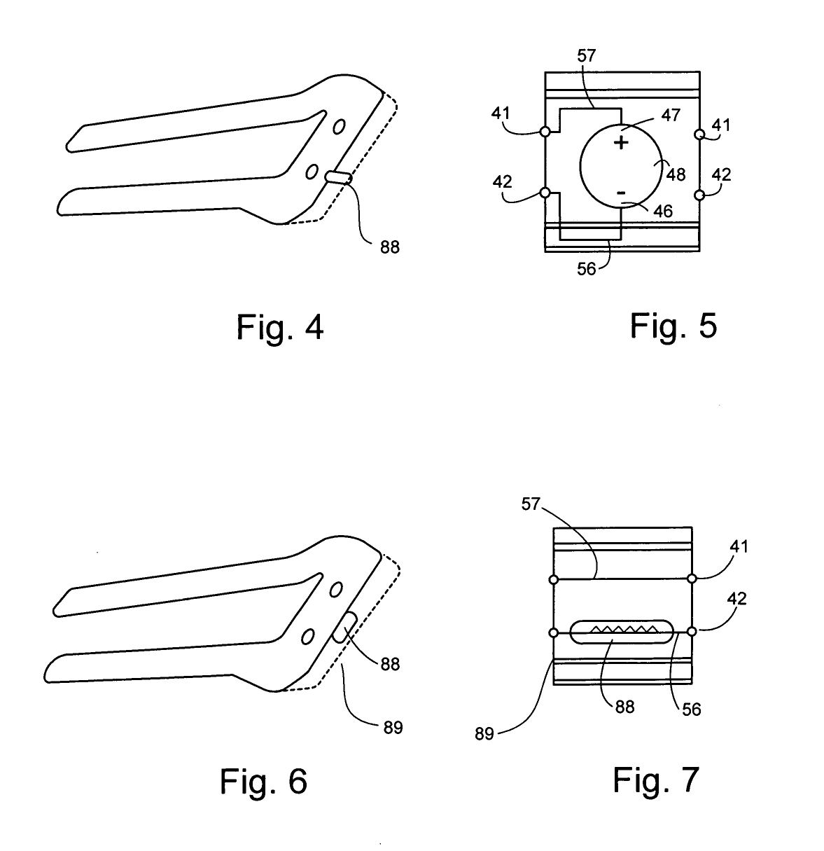

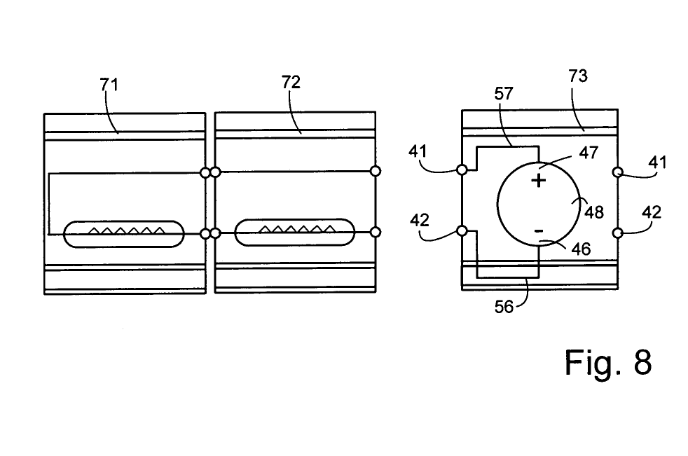

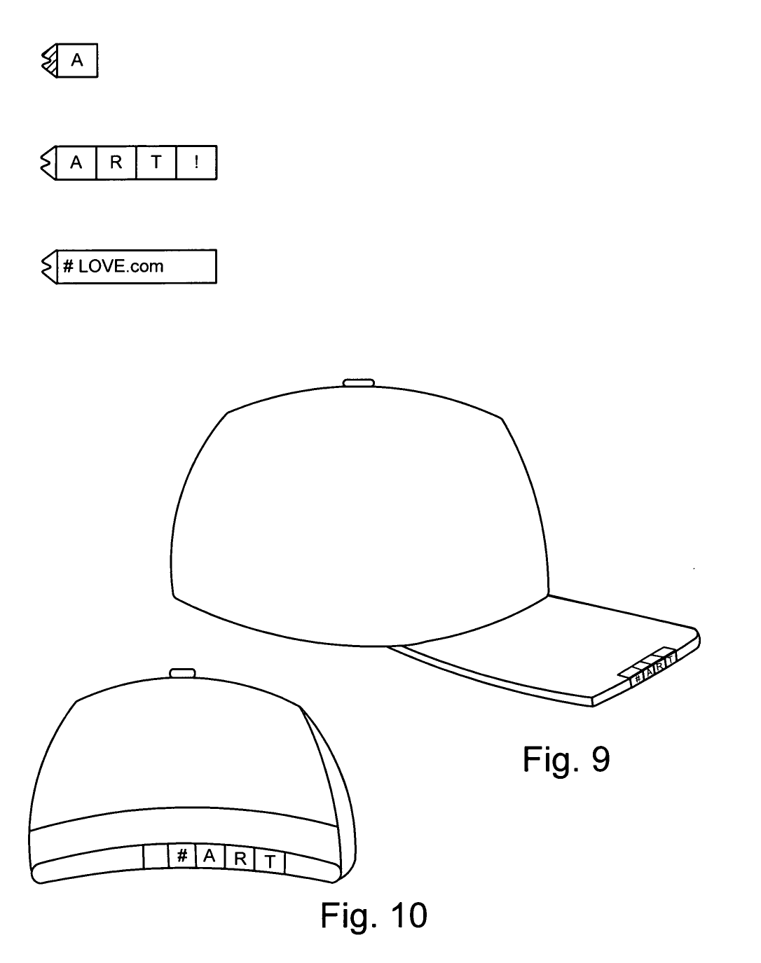

The following call out list of elements can be a useful guide in referencing the element numbers of the drawings.
11 Upper Prong Top Surface
12 Upper Prong Bottom Surface
13 Lower Prong Top Surface
14 Lower Prong Bottom Surface
15 Lower Prong Rear Bevel Face
16 Upper Prong Rear Bevel Face
17 Upper Prong Rear Tip
18 Lower Prong Rear Tip
19 Upper Prong Gap Protrusion
20 Upper Prong Forward Bend
21 Upper Prong Gap Notch
22 Front Member Inside Face
23 Front Member Lower
24 Front Member Outside Face
25 Front Member Top Edge
26 Front Member Lower Edge
31 Upper Prong
32 Lower Prong
33 Front Member
34 Prong Gap
35 Side Of Clip Body
41 Upper Electrical Connector
42 Lower Electrical Connector
43 Mask Edge
44 Background
45 Image
46 Negative Terminal
47 Positive Terminal
48 Battery
56 Negative Terminal Wire
57 Positive Terminal Wire
71 Terminating Clip
72 Intermediate Clip
73 Battery Clip
88 Led (Light-Emitting Diode)
89 Ultra Clear Reflective Face

### DETAILED DESCRIPTION OF THE PREFERRED EMBODIMENT

The present invention is a clip that can connect to a brim of a hat, or other article of clothing. The clip can be powered by an integral battery so that it is a battery enabled clip. Alternatively, the clip can be powered by an electrical circuit that receives power from a separate battery enabled clip. The clip can be connected in a sequential series to provide a continuous circuit. The clip can have an electrical connector such as a copper contact disposed on an outside surface of the clip.

The clip can be made of a resilient material such as wood, metal or plastic. The clip has a main body portion that provides a mechanical function, and the face of the clip can be a laminate such as a screenprinted layer of paint over a metallic foil, or a screenprinted layer of paint covered by a clear UV protective layer that has scratch resistance. A graphic such as a letter or number or picture can be screenprinted on the face of the clip.

The clip is made of a pair of prongs, namely an upper prong 31 and a lower prong 32. The clip also has a front member 33 connecting between the upper prong 31 and the lower prong 32. The pair of prongs are elongated in a horizontal direction such that the pair of prongs can be made from an extrusion of material. The upper prong 31 and the lower prong 32 are both flat planar members.

The upper prong has an upper prong top surface 11 that is generally flat. The upper prong also has an upper prong bottom surface 12. The upper prong bottom surface 12 poses a lower prong top surface 13. The lower prong also has a lower prong bottom surface 14.

A prong gap 34 is defined between the upper prong bottom surface 12 and the lower prong top surface 13. The prong gap is an elongated slot that could be formed from an extrusion, or an injection or cast mold. The prong gap 34 could also be formed by three-dimensional printing techniques. The prong gap 34 has an upper prong gap protrusion 19 which extends inward into the gap at an angle immediately before the upper prong gap notch 21. The prong gap 34 extends upwardly to an upper prong gap notch which is formed between the front member inside face 22 and the upper prong gap protrusion 19. The upper prong gap notch 21 can have a triangular profile or other acute angle profile. The gap can have an inside surface that is irregular having a grippy teeth profile for improved securing to an article of clothing such as the brim of a baseball cap.

The lower prong rear bevel face 15 faces upward and terminates at a lower prong rear tip 18. Similarly, the upper prong rear bevel face 16 faces upward and also terminates at an upper prong rear tip 17.

Opposing the upper prong gap protrusion 19 is an upper prong forward bend 20 formed on an upper prong top surface 11. The upper prong forward bend 20 extends the upper prong upward to a front member top edge 25 which is near an apex of the clip.

The front member 33 generally has a front member inside face 22 which opposes a front member outside face 24. The front member 33 is angled downward to provide a downward display. The front member lower face 23 connects to the lower prong, and the front member top edge 25 connects to the upper prong. The front member lower edge 26 forms a protrusion that may rest on a flat surface such as for display of the clip in a display mode when the clip is not attached to an article.

The front member outside face 24 provides a surface to mount ornamentation. Ornamentation can be in the form of letters, or other visual graphics. The letters can be illuminated. The accessory clip system can be formed of a plurality of adjacent clips such as a battery clip, terminating clip and display clip that can be arc or section shaped to provide a chain of clips that can be secured in a curved or arc shaped fashion to a curved brim of a hat. A top view of the clips shows that the clips do not necessarily have to have orthogonal sides.

To illuminate the letters, the clips generally include an upper electrical connector 41 and a lower electrical connector 42. The upper electrical connector 41 and the lower electrical connector 42 can extend from the clip body side 35. Preferably, the upper electrical connector 41 and the lower electrical connector 42 extend from the left clip body side and the right clip body side. When more than one clip is placed side-by-side, the clips can electrically connect between each other to provide a modularly constructed circuit. Each clip forms an electrical module.

The front member outside face 24 can have an image, logo, letter or a phrase. When variety of different clips are joined to each other side-by-side, the front member outside face 24 of each of the clips can form a combined message that can be customized and can be rearranged.

The image such as a letter can be traced on a mask edge 43 which defines an area between a background 44 and an image 45. The background 44 can be screenprinted with the image 45 as a more light permeable area, or the background can be a more light permeable area with the image 45 as a screenprinted area. The screenprinted area can be a light permeable area of varying light permeability such as a transparent or translucent plastic surface. The light permeable area can be made of a plastic lens such as an ultra clear reflective face 89 which could be made out of a resin that encapsulates the LED 88, or a pre-molded plastic lens.

The image can be eliminated using a battery 48. The battery 48 can have a positive terminal 47 and a negative terminal 46. The positive terminal 47 connects to a positive battery terminal wire 57 and the negative terminal 46 connects to a negative battery terminal wire 56. The negative battery terminal wire 56 can connect to the lower electrical connector 42. The positive battery terminal wire 57 can connect to the upper electrical connector 41. The battery terminal wires can extend as conductive wire, which can be manufactured as insulated wire, or as trace on a printed circuit board.

The electrical connectors, namely the upper electrical connector and the lower electrical connector can be made as contacts that are spring-loaded by helical springs, or spring-loaded as leaf springs. The electrical connector can be a copper contact that is semi-spherical in shape. The copper contact can be spring biased. The contacts can have a plug and socket connection as well. The contacts can electrically connect to each other also by means of adapters. Multiple clips can be aligned for completing an electrical circuit.

The configuration of the clip can require two or more clips to make a complete circuit by requiring termination of the circuit. For example, if a terminating clip has a connection from the positive terminal to the negative terminal or has a connection from the lower electrical connector to the upper electrical connector, then the terminating clip 71 is required to complete a circuit for a battery clip. One or more intermediate clips 72 can fit between the battery clip 73 and the terminating clip 71, but the intermediate clip cannot activate by itself. The battery clip 73 and the terminating clip act as bookends for framing a plurality of intermediate clips. The intermediate clips 72 are the display clips that display a graphic such as a letter, number, texture or picture.

An ultra clear reflective face 89 can be provided by metallic foil or metallic paint. The ultra clear reflective face can also be a clear finish over a screenprinted or inkjet printed surface, A variety of different surface finishing techniques can be used including reverse printing a graphic on a thin sheet of plastic that is adhered to the ultra clear reflective face 89.

1. An accessory clip system comprising:
a. a display clip having a front member, wherein the front member has a front member outside face and a front member inside face, wherein the front member has a flat area for displaying a graphic, wherein the display clip front member has a pair of sides, namely a left side and a right side;
b. a first prong of the display clip extending from the front member, wherein the first prong of the display clip has a generally flat and horizontal orientation; and
c. a second prong of the display clip extending from the front member, wherein the second prong of the display clip has a generally flat and horizontal orientation.

2. The accessory clip system of claim 1, further comprising:
a. a battery clip that has a battery housed within the battery clip, wherein the battery has a negative terminal and a positive terminal, wherein the negative terminal is connected to a negative terminal conductor and wherein the positive terminal is connected to a positive terminal conductor;
b. an electrical circuit connected to the battery clip;
c. an LED of the display clip mounted to the front member, wherein the LED is connected to the electrical circuit; and
d. a first prong of the battery clip extending from the front member, wherein the first prong of the battery clip has a generally flat and horizontal orientation; and
e. a second prong of the battery clip extending from the front member, wherein the second prong of the battery clip has a generally flat and horizontal orientation.

3. The accessory clip system of claim 2, wherein the electrical connector is a pair of external conductive contacts disposed on the left side or the right side.

4. The accessory clip system of claim 3, wherein the left side and the right side are generally flat.

5. The accessory clip system of claim 4, wherein the front member outside face is angled downward, but at not more than a 45° angle.

6. The accessory clip system of claim 5, wherein the accessory clip system further includes a terminating clip, wherein the terminating clip completes the electrical circuit wherein the accessory clip system does not complete the circuit without the terminating clip; and further comprising a first prong of the accessory clip extending from the front member, wherein the first prong of the accessory clip has a generally flat and horizontal orientation; and a second prong of the accessory clip extending from the front member, wherein the second prong of the accessory clip has a generally flat and horizontal orientation.

7. The accessory clip system of claim 6, wherein the electrical connector is a copper contact that is semi-spherical in shape.

8. The accessory clip system of claim 6, wherein for each prong of the clips of the accessory clip system, a lower prong rear bevel face faces upward and terminates at a lower prong rear tip and wherein an upper prong rear bevel face faces upward and terminates at an upper prong rear tip.
